(19) United States
(12) Patent Application Publication
(10) Pub. No.: US 2026/0320435 A1
(43) Pub. Date: Oct. 15, 2026

(54) METHOD OF ADAPTING ARTIFICIAL INTELLIGENCE MODEL FOR COMPOSITIONAL TASKS AND ELECTRONIC DEVICE FOR PERFORMING THE SAME

(71) Applicant: SAMSUNG ELECTRONICS CO., LTD., Suwon-si (KR)

(72) Inventors: Umberto MICHIELI, Chertsey (GB); Ondrej Bohdal, Chertsey (GB); Mete Ozay, Chertsey (GB); Jijoong Moon, Suwon-si (KR); Kyenghun Lee, Suwon-si (KR); Hyeonmok Ko, Suwon-si (KR)

(73) Assignee: SAMSUNG ELECTRONICS CO., LTD., Suwon-si (KR)

(21) Appl. No.: 19/467,403

(22) Filed: Feb. 2, 2026

Related U.S. Application Data
(63) Continuation of application No. PCT/KR2025/021400, filed on Dec. 11, 2025.

(30) Foreign Application Priority Data
Dec. 23, 2024 (GB) 2418969.8
May 29, 2025 (GB) 2508414.6
Jun. 10, 2025 (KR) 10-2025-0075763

(51) Int. Cl. G06N 5/04

(52) U.S. Cl. CPC G06N 5/04

(57) ABSTRACT

A method includes: obtaining a user input from a user; identifying, based on the user input, a first task and a second task; combining a first adapter corresponding to the first task with a second adapter corresponding to the second task to generate a combined adapter; calibrating the combined adapter by using one or more calibration parameters; generating an output corresponding to the user input, based on the calibrated combined adapter; and providing the generated output to the user.

### CROSS-REFERENCE TO RELATED APPLICATION(S)

This application is a continuation of PCT International Application No. PCT/KR2025/021400, which was filed on Dec. 11, 2025, and claims priority to Korean Patent Application No. 10-2025-0075763, filed on Jun. 10, 2025 in the Korean Intellectual Property Office, and claims priority to UK Patent Application No. 2508414.6, filed on May 29, 2025, and claims priority to UK patent Application No. 2418969.8, filed on Dec. 23, 2024, the disclosures of each of which are incorporated by reference herein their entirety.

### BACKGROUND

### 1. Field

The disclosure relates to adapting an artificial intelligence (AI) model, and more particularly, to a method of adapting an AI model for a compositional task and an electronic device for performing the same.

### 2. Description of Related Art

Recently, with the development of artificial intelligence (AI) technology, the field of natural language processing (NLP) has rapidly grown. In particular, large language models (LLMs) are attracting attention as technologies are becoming capable of performing text generation, translation, summarization, and question response at a level similar to the level of humans. Language models enable natural interaction with humans and provide practical value in various industries including healthcare, finance, education, and the like. For example, LLMs may analyze a user request and then process a task by dynamically calling an appropriate function or connecting to an external system. Accordingly, LLMs may contribute to improving efficiency and user experience in various services, such as virtual assistants or smart home control.

### SUMMARY

According to an aspect of the disclosure, a method includes: obtaining a user input from a user; identifying, based on the user input, a first task and a second task; combining a first adapter corresponding to the first task with a second adapter corresponding to the second task to generate a combined adapter; calibrating the combined adapter by using one or more calibration parameters; generating an output corresponding to the user input, based on the calibrated combined adapter; and providing the generated output to the user.

According to an aspect of the disclosure, a non-transitory computer-readable recording medium having instructions stored therein, which when executed by a computer, cause the computer to perform a method including obtaining a user input from a user; identifying, based on the user input, a first task and a second task; combining a first adapter corresponding to the first task with a second adapter corresponding to the second task to generate a combined adapter; calibrating the combined adapter by using one or more calibration parameters; generating an output corresponding to the user input, based on the calibrated combined adapter; and providing the generated output to the user

According to an aspect of the disclosure, an electronic device includes: memory storing instructions; and at least one processor operatively coupled to the memory and comprising processing circuitry, in which the instructions, when executed by the at least one processor individually or collectively, cause the electronic device to: obtain a user input from a user; identify a first task and a second task, based on the user input; combine a first adapter corresponding to the first task with a second adapter corresponding to the second task to generate a combined adapter; calibrate the combined adapter by using one or more calibration parameters; generate an output corresponding to the user input, based on the calibrated combined adapter; and provide the generated output to the user.

According to an aspect of the disclosure, an electronic device includes: memory storing instructions; and at least one processor operatively coupled to the memory and comprising processing circuitry, in which the instructions, when executed by the at least one processor individually or collectively, cause the electronic device to: obtain a user input from a user; identify a first task and a second task, based on the user input; combine a first adapter corresponding to the first task with a second adapter corresponding to the second task to generate a combined adapter; calibrate the combined adapter by using one or more calibration parameters; generate an output corresponding to the user input, based on the calibrated combined adapter; and provide the generated output to the user.

### BRIEF DESCRIPTION OF DRAWINGS

FIG. 1 illustrates operations performed by an electronic device, according to one or more embodiments of the disclosure.

FIG. 2 illustrates a block diagram of a system according to an embodiment of the disclosure.

FIG. 3 illustrates an inference model executed by an electronic device, according to an embodiment of the disclosure.

FIG. 4 illustrates a set of adapters associated with an inference model executed by an electronic device, according to an embodiment of the disclosure.

FIG. 5 illustrates a flowchart of a method performed by an electronic device, according to an embodiment of the disclosure.

FIG. 6 illustrates operations performed by an electronic device, according to an embodiment of the disclosure.

FIG. 7 illustrates combining adapters to form a combined adapter and calibrating the combined adapter, according to an embodiment of the disclosure.

FIG. 8 illustrates combining adapters to form a combined adapter and calibrating the combined adapter, according to an embodiment of the disclosure.

FIG. 9 illustrates combining adapters to form a combined adapter and calibrating the combined adapter, according to an embodiment of the disclosure.

FIG. 10A illustrates calibration parameters according to an embodiment of the disclosure.

FIG. 10B illustrates calibration parameters according to an embodiment of the disclosure.

FIG. 11 illustrates a flowchart of a method, performed by a server, of training calibration parameters, according to an embodiment of the disclosure.

FIG. 12 illustrates a flowchart of a method performed by an electronic device, according to an embodiment of the disclosure.

### DETAILED DESCRIPTION

As for the terms as used in embodiments of the present specification, common terms that are currently widely used are selected as much as possible while taking into account the functions of the disclosure. However, the terms may vary depending on the intention of those of ordinary skill in the art, precedents, the emergence of new technology, and the like. Also, in a specific case, there are also terms arbitrarily selected by the applicant. In this case, the meaning of the terms will be described in detail in the description of the corresponding embodiment of the disclosure. Therefore, the terms as used in the present specification should be defined based on the meaning of the terms and the description throughout the disclosure rather than simply the names of the terms.

The terms as used in the disclosure are only used to describe a specific embodiment of the disclosure, and are not intended to limit the disclosure. The singular forms as used herein are intended to include the plural forms as well unless the context clearly indicates otherwise. Unless defined otherwise, all terms including technical or scientific terms as used herein have the same meaning as commonly understood by those of ordinary skill in the art disclosed in the present specification. It will be understood that terms, such as those defined in commonly used dictionaries, should be interpreted as having a meaning that is consistent with their meaning in the context of the relevant art and will not be interpreted in an idealized or overly formal sense unless expressly so defined herein. In some cases, even when terms are defined in the disclosure, the terms should not be interpreted to exclude embodiments of the disclosure.

In the disclosure described below, hardware approaches are described in one or more examples. However, because the disclosure includes technologies using both hardware and software, the disclosure do not exclude software-based approaches.

Throughout the disclosure, the expression “a portion includes a certain element” means that a portion further includes other elements rather than excludes other elements unless otherwise stated. Also, the terms such as “unit” and “module” described in the specification mean units that process at least one function or operation, and may be implemented as hardware, software, or a combination of hardware and software.

The expression “configured to” as used in the disclosure may be used interchangeably with, for example, “suitable for,” “having the capacity to,” “designed to,” “adapted to,” “made to,” or “capable of” depending on a situation. The term “configured to” may not necessarily mean only “specifically designed to” in hardware. Alternatively, in some situations, the expression “a system configured to” mean that the system is “capable of . . . ” with other devices or components. For example, “a processor configured to perform A, B, and C” may refer to a dedicated processor (e.g., an embedded processor) for performing corresponding operations or a generic-purpose processor capable of performing corresponding operations by executing one or more software programs stored in memory.

When one element is referred to as being “connected” or “coupled” to another element, the one element may be directly connected or coupled to the other element, but it will be understood that the elements may be connected or coupled to each other via an intervening element therebetween unless otherwise stated.

In the disclosure, expressions “greater than” or “less than” may be used to determine whether a specific condition is satisfied or fulfilled; however, this is only a description for expressing an example and does not exclude expressions “greater than or equal to” or “less than or equal to.” Conditions written as “greater than or equal to” may be replaced with “greater than,” conditions written as “less than or equal to” may be replaced with “less than,” and conditions written as “greater than or equal to and less than” may be replaced with “greater than and less than or equal to.”

It will be understood that the blocks in the flowcharts and combinations of the flowcharts in the disclosure may be performed by one or more computer programs including computer-executable instructions. The one or more computer programs may be stored in single memory, or may be segmented and stored in a plurality of different memories.

All functions or operations described in the disclosure may be processed by a single processor or a combination of processors. The single processor or the combination of processors is circuitry that performs processing and may include circuitry, such as an application processor (AP), a communication processor (CP), a graphics processing unit (GPU), a neural processing unit (NPU), a microprocessor unit (MPU), a system on chip (SoC), or an integrated circuit (IC).

One or more processors, according to the disclosure, may include at least one of a CPU, a GPU, an accelerated processing unit (APU), a many integrated core (MIC), a digital signal processor (DSP), or an NPU. One or more processors may be implemented in the form of an integrated SoC including one or more electronic components. One or more processors may each be implemented as separate hardware (H/W).

When the method according to an embodiment of the disclosure includes a plurality of operations, the operations may be performed by one processor or a plurality of processors. For example, when a first operation, a second operation, and a third operation are performed by the method according to an embodiment of the disclosure, the first operation, the second operation, and the third operation may all be performed by a first processor. Alternatively, the first operation and the second operation may be performed by a first processor (e.g., a generic-purpose processor) and the third operation may be performed by a second processor (e.g., a dedicated artificial intelligence (AI) processor). However, the disclosure is not limited thereto.

One or more processors according to the disclosure may be implemented as a single core processor, or may be implemented as a multicore processor.

When the method according to an embodiment of the disclosure includes a plurality of operations, the plurality of operations may be performed by one core, or may be performed by a plurality of cores included in one or more processors.

AI-related functions according to the disclosure are operated through a processor and memory. The processor may be implemented as one or more processors. In this case, one or more processors may be a generic-purpose processor, such as a CPU, an AP, or a DSP, a dedicated graphics processor, such as a GPU or a vision processing unit (VPU), or a dedicated AI processor, such as an NPU. One or more processors may perform control so that input data is processed in accordance with a predefined operation rule or AI model, which is stored in the memory. Alternatively, when one or more processors are dedicated AI processors, the dedicated AI processors may be designed with a hardware structure specialized for processing a specific AI model.

The predefined operation rule or AI model is made through learning. The expression “being made through learning” means that the predefined operation rule or AI model configured to perform desired characteristics (or purposes) is made in such a manner that a basic AI model is trained by using a large number of training data by a learning algorithm. Such learning may be performed by the device itself on which the AI according to the disclosure is performed, or may be performed through a separate server and/or system. Examples of the learning algorithm may include supervised learning, unsupervised learning, semi-supervised learning, or reinforcement learning, but the disclosure is not limited to the examples described above.

The AI model may include a plurality of neural network layers. Each of the neural network layers has a plurality of weights and performs neural network operations through operations between the plurality of weights and an operation result of a previous layer. The plurality of weights that the plurality of neural network layers have may be optimized by the learning result of the AI model. For example, the plurality of weights may be updated so that a loss value or a cost value obtained by the AI model during the learning process is reduced or minimized. An artificial neural network may include a deep neural network (DNN), for example, a convolutional neural network (CNN), a recurrent neural network (RNN), a restricted Boltzmann machine (RBM), a deep belief network (DBN), a bidirectional recurrent deep neural network (BRDNN), or deep Q-networks, etc., but the disclosure is not limited thereto.

In an embodiment of the disclosure, a “language model (LM)” may refer to an AI model designed for natural language processing (NLP), such as language understanding or language generation. For example, the LM may be understood as an AI model that is trained to generate an output in the form of natural language, based on input data. The LM may be an AI model that is trained to generate and output natural language descriptions of input data by using natural language processing technology.

A large language model (LLM) may be a natural language processing model or LM that is trained based on a large dataset. The LLM may be used to perform various tasks, such as sentence prediction, translation, summarization, and question response. The LLM has excellent performance because the LLM is trained with large computing resources and time, but the LLM may require a lot of computing resources and memory for training.

In the disclosure, in one or more examples, a “pre-trained model” may refer to a model that has trained general knowledge or patterns in advance by using a large dataset. The pre-trained model may be understood as a model that is trained by using a large dataset and universally usable across various tasks. The pre-trained model may also be referred to as a “base model” or a “foundation model.” In one or more examples, a pre-trained model may be pre-loaded onto an electronic apparatus. In one or more examples, a pre-trained model may be downloaded to the electronic apparatus via a connection with a server that stores the pre-trained model. In one or more examples, the pre-trained model may be updated or fine-tuned based on how the pre-trained model is used by a specific user.

In the disclosure, a “task” may refer to a specific goal or mission designed and trained to be performed by a model. The task of the model may be understood as a task to be solved by generating an expected output from a given input. The task may represent different domains of expertise (e.g., math or biology question response), different downstream tasks (e.g., summarization, translation, etc.), or different convergence points of optimization (e.g., different runs of an LLM training experiment).

In the disclosure, “fine-tuning” may refer to a process of additionally training a pre-trained model so as to be suitable for a particular task. More precise performance may be achieved by fine-tuning the weight of the model by using a new dataset. Through the fine-tuning, high performance may be achieved by using far fewer resources and less time than training the model by targeting a particular task from the beginning.

In the disclosure, a “downstream task” may refer to a specific task or application in which a pre-trained model is fine-tuned to achieve a particular goal. The downstream task may correspond to the goal of adapting and optimizing the general capabilities of the pre-trained model to solve specific scenarios or tasks. For example, the downstream task of the LLM may include specific and specialized roles, such as text summarization or translation assigned to the LLM.

In the disclosure, a “learnable” parameter may refer to a parameter that is updatable, changeable, or variant during learning. In the disclosure, a “frozen” parameter may refer to a fixed or invariant parameter.

In one or more examples, parameter-efficient fine-tuning (PEFT) may be used to utilize an LLM efficiently. The PEFT trains only a small number of parameters to fine-tune a model, allowing the model to adapt for a particular downstream task with relatively few resources. For example, by training only a small number of parameters, while freezing all or some of the pre-trained parameters, PEFT enables rapid fine-tuning for various downstream tasks. Through the PEFT, necessary parts may be fine-tuned while the main structure of the pre-trained model is maintained.

A pre-trained base model using general training data may be fine-tuned or adapted to perform a particular task. For example, the entire parameters of the pre-trained model may be retrained (or updated) by targeting a particular task. However, as the number of parameters of the pre-trained model increases rapidly, updating all parameters of the pre-trained model may require a lot of computing resources, long training time, and a lot of memory. Accordingly, instead of fully retraining the pre-trained model, tuning only some parameters of the pre-trained model or training additional layer(s) (e.g., an adapter module) for a target task may be taken into account.

In an embodiment of the disclosure, for efficient fine-tuning of the pre-trained base model, weighted matrices of the pre-trained model may be fixed, while only one or more additional low-rank weighted matrices may be trained for a target task. The one or more low-rank weighted matrices may have a lower rank than a weighted matrix of a pre-trained neural network model. The parameters of the pre-trained neural network model may be frozen and only the parameters of the low-rank matrices may be trained by targeting a particular task (or a particular domain).

To support a plurality of tasks with a single model, merging two or more models may be taken into account. Model merging may allow a model to be used for tasks that have not been trained, without the need for retraining or fine-tuning. A resulting model obtained by model merging may perform a plurality of tasks by using one or more single sets of weights. The resulting model may be expected to perform a plurality of tasks on a given input.

In an embodiment of the disclosure, a plurality of single-task adapters may be reconstructed to perform a compositional task including a plurality of tasks. The plurality of adapters may be single-task-combined and calibrated to form a joint-expert adapter. Accordingly, instead of performing multiple inferences by using a plurality of adapters for a plurality of tasks, an output for a plurality of tasks of a given input may be generated through single inference. Furthermore, instead of storing new adapters for each of possible compositional tasks, calibration parameters with a relative small size may be used to reconstruct adapters. Accordingly, a storage space required to store the model may be reduced and a computing speed may be improved.

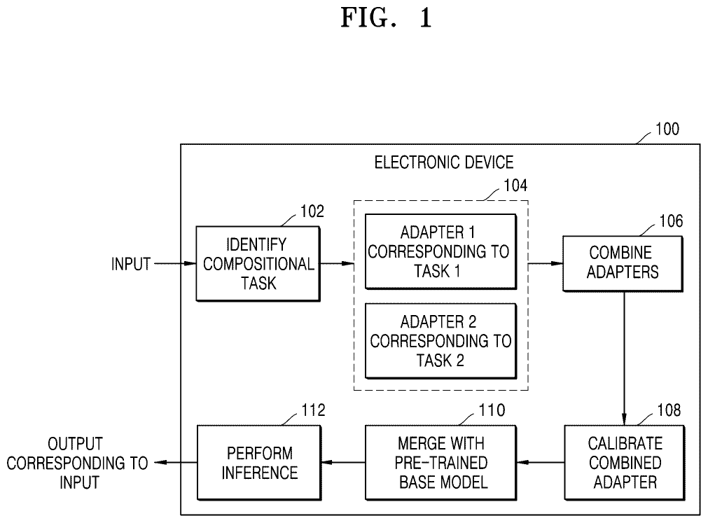

FIG. 1 illustrates operations performed by an electronic device 100, according to an embodiment of the disclosure.

Referring to FIG. 1, the electronic device 100 may receive a user input. The electronic device 100 may perform operations 102, 106, 108, 110, and 112. By performing operations 102, 106, 108, 110, and 112, the electronic device 100 may generate an output corresponding to the user input. However, the disclosure is not limited thereto, and operations 102, 106, 108, 110, and 112 may be performed by an arbitrary electronic device individually or by a plurality of electronic devices collectively. The electronic device 100 may omit any one of the operations illustrated in FIG. 1, and/or may additionally perform operations not illustrated in FIG. 1. In an embodiment of the disclosure, the order of at least some of operations 102, 106, 108, 110, and 112 may be changed.

In operation 102, the electronic device 100 may identify a compositional task indicated by the user input. In an embodiment of the disclosure, the “compositional task” may refer to a set of a plurality of tasks. In one or more examples, “a compositional task” may be based on a user input in natural language form. For example, a user input may be the text “calculate how long to drive from point A to point B and estimate the amount of fuel to drive from point A to point B. The electronic device 100 may analyze the user input and identify (or determine) a task to achieve a goal indicated by the user input. The electronic device 100 may identify whether the identified task is the compositional task. Based on identifying that the identified task is a combination of a plurality of tasks supported by the electronic device 100, the electronic device 100 may identify that the identified task is the compositional task.

In an embodiment of the disclosure, the user input may include a request for a particular task. The electronic device 100 may identify a request for a particular task included in the user input. To perform the request included in the user input, the electronic device 100 may decompose the particular task into one or more downstream tasks. For example, the electronic device 100 may analyze the user input to identify the goal of the user input. The electronic device 100 may identify a task to be performed to achieve the goal of the user input. In an embodiment of the disclosure, the user input may include an input prompt.

In an embodiment of the disclosure, the user input may include a request for a particular task and target data to which the task is to be applied. For example, the target data may include any combination of various forms, such as text data, image data, video data, or audio data. The user input may be obtained from a user of the electronic device 100, an application, software, or computer program running on the electronic device 100, an electronic device external to the electronic device 100, or any combination thereof. The request for the particular task and the target data may be obtained from a single entity. For example, the electronic device 100 may receive the request for the particular task and the target data from the user (e.g., in case that text and a request for a Spanish translation of the text are received from the user). The request for the particular task and the target data may be obtained from different entities. For example, the electronic device 100 may receive the target data from the application running on the electronic device 100, and may receive the request for the particular task with respect to the target data from the user (for example, in case that a request for a Spanish summarization of English text provided by the application is received from the user).

In an embodiment of the disclosure, the electronic device 100 may identify whether the task indicated by the user input is a compositional task that includes a plurality of downstream tasks. The electronic device 100 may trigger reconstruction of adapters, based on identifying that the task indicated by the user input is the compositional task.

In operation 106, the electronic device 100 may combine adapters 104 corresponding to each task included in the compositional task identified in operation 102. For example, based on identifying that the compositional task identified in operation 102 is a combination of “task 1” and “task 2,” the electronic device 100 may combine “adapter 1” corresponding to “task 1” with “adapter 2” corresponding to “task 2.” In an embodiment of the disclosure, the electronic device 100 may store pre-trained adapters for each of the tasks supported by the electronic device 100. The electronic device 100 may load an adapter corresponding to each task included in the identified compositional task among the stored adapters.

In operation 106, the electronic device 100 may merge the adapters 104 by using at least one of various methods. In an embodiment of the disclosure, the electronic device 100 may obtain a combined adapter of the adapters by performing linear merging on the adapters 104. For example, the weights of the combined adapter may be obtained by computing a weighted average of the weights of the adapters. In an embodiment of the disclosure, the electronic device 100 may compute the weighted average by applying the same weights to the adapters or by applying defined (e.g., predefined or predetermined) weights to the respective adapters.

In operation 108, the electronic device 100 may calibrate the combined adapter of the adapters. The electronic device 100 may calibrate the combined adapter by using one or more calibration parameters. In operation 108, the combined adapter may be calibrated to be specific for the compositional task identified in operation 102. In an embodiment of the disclosure, the electronic device 100 may add the one or more calibration parameters to the combined adapter. The one or more calibration parameters may be referred to as additional parameters.

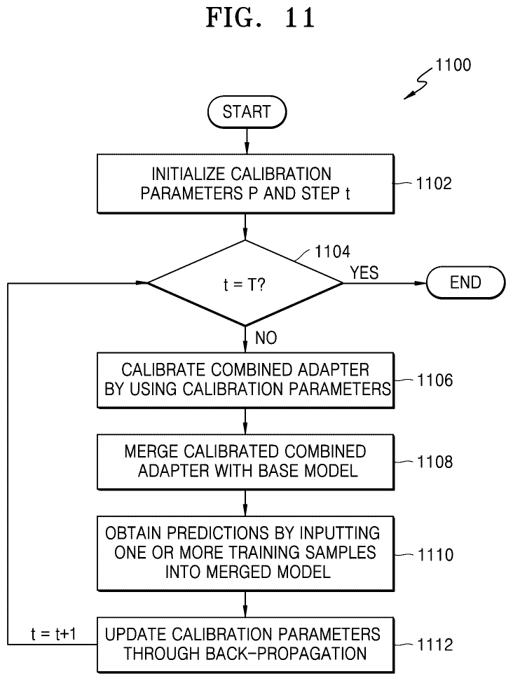

In an embodiment of the disclosure, the one or more calibration parameters may be learnable parameters. For example, the calibration parameters may be trained by combining single-task adapters to form a combined adapter, calibrating the combined adapter by using the calibration parameters, and updating the calibrated combined adapter by using training data. The training of the calibration parameters is described in detail below with reference to FIG. 11.

In an embodiment of the disclosure, the one or more calibration parameters may be a row vector or a column vector. The electronic device 100 may calibrate the combined adapter by performing an element-wise addition of the one or more calibration parameters on one or more weighted matrices of the combined adapter. For example, the electronic device 100 may perform an element-by-column addition on a matrix of the one or more calibration parameters and a weighted matrix of the combined adapter.

In an embodiment of the disclosure, the one or more calibration parameters may construct one or more calibration matrices. For example, a first calibration matrix may include a first set of one or more calibration parameters, and a second calibration matrix may include a second set of one or more calibration parameters. The electronic device 100 may calibrate the combined adapter by performing an addition on the calibration matrices and the weighted matrices of the combined adapter. The number of calibration matrices may be equal to the number of weighted matrices of the adapter.

In operations 106 and 108, the plurality of single-task adapters may be reconstructed into a multi-task adapter. The electronic device 100 may obtain a joint-expert adapter for a compositional task by combining and calibrating the plurality of single-task adapters. The reconstructed adapter may be used during inference.

In operation 110, the electronic device 100 may merge the calibrated combined adapter with the base model. The base model may correspond to a pre-trained AI model or a pre-trained neural network model. The base model may also be referred to as a foundation model. By merging the calibrated combined adapter with the base model, the electronic device 100 may obtain an inference model specific for the compositional task identified in operation 102.

In an embodiment of the disclosure, the electronic device 100 may store one or more adapters that support various individual downstream tasks (e.g., translation, summarization, etc.) along with the base model. The electronic device 100 may fine-tune the base model for the particular task (or tasks) by applying one or more adapters to the base model. For example, to generate the output corresponding to the user input, the electronic device 100 may load one or more adapters corresponding to each of one or more tasks indicated by the user input. The electronic device 100 may obtain an inference model by adding the loaded one or more adapters to the base model. The inference model may correspond to the base model updated based on the one or more adapters. Accordingly, the adapters may be used to fine-tune the pre-trained base model to generate a fine-tuned model that is configured to handle the one or more tasks indicated by the user input.

In operation 112, the electronic device 100 may perform inference by using the obtained inference model. By inputting the user input into the inference model, the electronic device 100 may infer the output corresponding to the user input. The inference model may generate the output, based on the user input. The electronic device 100 may provide, to the user, the output generated by the inference model.

In an embodiment of the disclosure, the electronic device 100 may combine the plurality of adapters so as to perform the compositional task. The electronic device 100 may calibrate the combined adapter of the adapters. For example, the electronic device 100 may identify a plurality of downstream tasks for performing the compositional task. The electronic device 100 may obtain a plurality of adapters corresponding to each of the plurality of downstream tasks. The electronic device 100 may combine the plurality of obtained adapters. The electronic device 100 may calibrate the combined adapter to be specific for a given compositional task by a relatively small number of calibration parameters. The number of calibration parameters may be negligible, compared to the use of a new adapter specific for the compositional task. For example, the number of calibration parameters may be relatively small or insignificant, compared to the total number of parameters of the plurality of adapters each specific for any combination of downstream tasks supported by the electronic device 100. For example, assuming a number of total parameters of a general adapter are around 30 million (e.g., an adapter with a size of 50 MB), the number of calibration parameters may be 20 to 160 thousand (e.g., a set of calibration parameters with a size of 0.05 MB to 0.3 MB), of which the size may be negligible. Accordingly, the electronic device 100 may support various compositional tasks with less storage space.

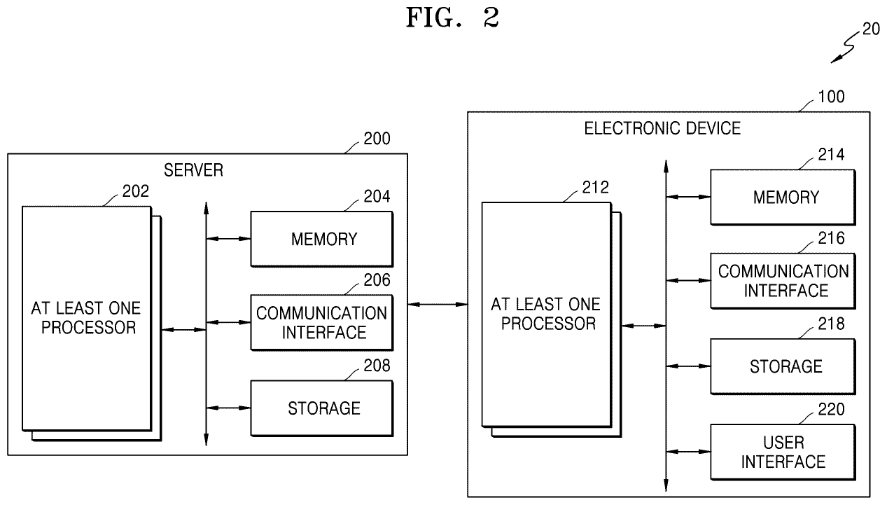

FIG. 2 illustrates a block diagram of a system 20 according to an embodiment of the disclosure.

Referring to FIG. 2, the system 20 may include a server 200 and an electronic device 100. The server 200 may include at least one processor 202, memory 204, a communication interface 206, and a storage 208. Only essential components for explaining the functions and/or operations of the server 200 are illustrated in FIG. 2, and components included in the server 200 are not limited to those illustrated in FIG. 2. The configuration of the server 200 illustrated in FIG. 2 is only an example, and examples of the server 200 that performs an embodiment of the disclosure are not limited to the configuration illustrated in FIG. 2. In an embodiment of the disclosure, one or more of the components of the server 200 illustrated in FIG. 2 may be omitted or changed, or components not illustrated in FIG. 2 may be added to the server 200. In an embodiment of the disclosure, all or some of the at least one processor 202, the memory 204, the communication interface 206, and the storage 208 may be implemented in the form of a single chip.

The at least one processor 202 is configured to control a series of processes so that the server 200 operates according to the following embodiments of the disclosure, and may be implemented as one or more processors. The one or more processors included in the at least one processor 202 may be circuitry, such as an SoC or an IC. The one or more processors included in the at least one processor 202 may be a generic-purpose processor, such as a CPU, an MPU, an AP, or a DSP, a dedicated graphics processor, such as a GPU or a VPU, a dedicated AI processor, such as an NPU, or a dedicated communication processor, such as a CP. When the one or more processors included in the at least one processor 202 are a dedicated AI processor, the dedicated AI processor may be designed with a hardware structure specific for processing a particular AI model.

The at least one processor 202 may control the overall operations of the server 200. In one or more examples, the at least one processor 202 may control the server 200 to perform at least some of the operations according to an embodiment of the disclosure described below. For example, the at least one processor 202 may transmit and receive signals through the communication interface 206. The at least one processor 202 may write data to the memory 204 and read the data written to the memory 204. For example, the at least one processor 202 may execute one or more instructions of a program stored in the memory 204 to process data in accordance with a predefined operation rule or AI model. Accordingly, the at least one processor 202 may perform operations described in the following embodiments of the disclosure. In the disclosure, operations described as being performed by the server 200 or the components 202, 204, 206, and 208 included in the server 200 may be understood as being performed by the at least one processor 202 unless otherwise stated. The at least one processor 202 may access data stored in the storage 208. The at least one processor 202 may load data stored in the storage 208 into the memory 204.

The at least one processor 202 may include a variety of processing circuitry and/or a plurality of processors. In an embodiment of the disclosure, the “processor” may include at least one processor, and In one or more examples, may include a variety of processing circuitry. The one or more processors individually and/or collectively may be configured to perform various functions described in the disclosure in a distributed manner. As used herein, the “processor,” “at least one processor,” and “one or more processors” may be configured to perform various functions. However, these terms may cover, without limitation, a situation where one processor performs some functions and other processor(s) perform other functions, and a situation where a single processor may perform all functions. In addition, the at least one processor may include a combination of processors that perform the disclosed various functions in a distributed manner. The at least one processor individually or collectively may execute program instructions to accomplish or perform various functions.

The memory 204 may store instructions, data structures, and/or program codes, which may be read by the at least one processor 202. The memory 204 may store a program or at least one instruction for performing operations according to the following embodiments of the disclosure. The memory 204 may provide the stored data to the at least one processor 202 in response to a request from the at least one processor 202. For example, the memory 204 may store data such as configuration information, application programs, and basic programs for the operation of the server 200. In an embodiment of the disclosure, the memory 204 may store instructions that, when executed by the at least one processor 202 individually or collectively, cause the server 200 to perform at least some of the operations of the server 200 described below. For example, the at least one processor 202 may execute one or more instructions or codes stored in the memory 204 to perform at least some of the operations of the server 200 described in the disclosure.

The memory 204 may include flash memory-type memory, hard disk-type memory, multimedia card micro-type memory, or card-type memory, and may include non-volatile memory including at least one of read-only memory (ROM), electrically erasable programmable read-only memory (EEPROM), programmable read-only memory (PROM), magnetic memory, magnetic disk, or optical disk, and/or volatile memory, such as random access memory (RAM) or static random access memory (SRAM).

The communication interface 206 may be a component for transmitting and receiving signals (control commands, data, etc.) with an external device in a wired or wireless manner. The communication interface 206 may be implemented to include a communication chipset that supports various communication protocols. The communication interface 206 may receive a signal from the outside and provide the received signal to the at least one processor 202. The communication interface 206 may transmit, to the outside, a signal output from the at least one processor 202. The server 200 may communicate with the external device (e.g., the electronic device 100) through the communication interface 206.

The storage 208 may store data associated with the operation of the server 200. The storage 208 may store instructions, program codes, and/or software for the operations of the server 200. The storage 208 may store data to be processed by the at least one processor 202 and/or a processing result of the at least one processor 202. In an embodiment of the disclosure, the storage 208 may store data to be distributed to the electronic device 100. For example, the storage 208 may store at least one of one or more weighted matrices included in the AI model to be executed by the electronic device 100, one or more weighted matrices to be applied to the AI model, one or more weighted matrices of one or more adapters for fine-tuning the AI model, or one or more parameters used for fine-tuning the AI model. The storage 208 may include one or more storage media. The storage 208 may include at least one of non-volatile memory or volatile memory. The at least one processor 202 may load data stored in the storage 208 into the memory 204 and process the data loaded into the memory 204.

The electronic device 100 may include at least one processor 212, memory 214, a communication interface 216, a storage 218, and a user interface 220. Only essential components for explaining the functions and/or operations of the electronic device 100 are illustrated in FIG. 2, and components included in the electronic device 100 are not limited to those illustrated in FIG. 2. The configuration of the electronic device 100 illustrated in FIG. 2 is only an example, and examples of the electronic device 100 that performs an embodiment of the disclosure are not limited to the configuration illustrated in FIG. 2. In an embodiment of the disclosure, one or more of the components of the electronic device 100 illustrated in FIG. 2 may be omitted or changed, or components not illustrated in FIG. 2 may be added to the electronic device 100. In an embodiment of the disclosure, all or some of the at least one processor 212, the memory 214, the communication interface 216, the storage 218, and the user interface 220 may be implemented in the form of a single chip.

The at least one processor 212 is configured to control a series of processes so that the electronic device 100 operates according to the following embodiments of the disclosure, and may be implemented as one or more processors. One or more processors included in the at least one processor 212 may be circuitry, such as an SoC or an IC. The one or more processors included in the at least one processor 212 may be a generic-purpose processor, such as a CPU, an MPU, an AP, or a DSP, a dedicated graphics processor, such as a GPU or a VPU, a dedicated AI processor, such as an NPU, or a dedicated communication processor, such as a CP. When the one or more processors included in the at least one processor 212 are a dedicated AI processor, the dedicated AI processor may be designed with a hardware structure specific for processing a particular AI model.

The at least one processor 212 may control the overall operations of the electronic device 100. In one or more examples, the at least one processor 212 may control the electronic device 100 to perform at least some of the operations according to an embodiment of the disclosure described below. For example, the at least one processor 212 may transmit and receive signals through the communication interface 216. The at least one processor 212 may write data to the memory 214 and read the data written to the memory 214. For example, the at least one processor 212 may execute one or more instructions of a program stored in the memory 214 to process data in accordance with a predefined operation rule or AI model. Accordingly, the at least one processor 212 may perform operations described in the following embodiments of the disclosure. In the disclosure, operations described as being performed by the electronic device 100 or the components 212, 214, 216, 218, and 220 included in the electronic device 100 may be understood as being performed by the at least one processor 212 unless otherwise stated. The at least one processor 212 may access data stored in the storage 218. The at least one processor 212 may load data stored in the storage 218 into the memory 214.

The at least one processor 212 may include a variety of processing circuitry and/or a plurality of processors. In an embodiment of the disclosure, the “processor” may include at least one processor, and In one or more examples, may include a variety of processing circuitry. The one or more processors individually and/or collectively may be configured to perform various functions described in the disclosure in a distributed manner. As used herein, the “processor,” “at least one processor,” and “one or more processors” may be configured to perform various functions. However, these terms may cover, without limitation, a situation where one processor performs some functions and other processor(s) perform other functions, and a situation where a single processor may perform all functions. In addition, the at least one processor may include a combination of processors that perform the disclosed various functions in a distributed manner. The at least one processor individually or collectively may execute program instructions to accomplish or perform various functions.

The memory 214 may store instructions, data structures, and/or program codes, which may be read by the at least one processor 212. The memory 214 may store a program or at least one instruction for performing operations according to the following embodiments of the disclosure. The memory 214 may provide the stored data to the at least one processor 212 in response to a request from the at least one processor 212. For example, the memory 214 may store data such as configuration information, application programs, and basic programs for the operation of the electronic device 100. In an embodiment of the disclosure, the memory 214 may store instructions that, when executed by the at least one processor 212 individually or collectively, cause the electronic device 100 to perform at least some of the operations of the electronic device 100 described below. For example, the at least one processor 212 may execute one or more instructions or codes stored in the memory 214 to perform at least some of the operations of the electronic device 100 described in the disclosure.

The memory 214 may include flash memory-type memory (or storage medium), hard disk-type memory (or storage medium), multimedia card micro-type memory (or storage medium), or card-type memory (or storage medium). The memory 214 may include non-volatile memory including at least one of ROM, EEPROM, PROM, magnetic memory, magnetic disk, or optical disk, and/or volatile memory, such as RAM or SRAM.

The communication interface 216 may be a component for transmitting and receiving signals (control commands, data, etc.) with an external device in a wired or wireless manner. The communication interface 216 may be implemented to include a communication chipset that supports various communication protocols. The communication interface 216 may receive a signal from the outside and provide the received signal to the at least one processor 212. The communication interface 216 may transmit, to the outside, a signal output from the at least one processor 212. The electronic device 100 may communicate with the external device (e.g., the server 200) through the communication interface 216.

The storage 218 may store data associated with the operation of the electronic device 100. The storage 218 may store instructions, program codes, and/or software for the operations of the electronic device 100. The storage 218 may store data to be processed by the at least one processor 212 and/or a processing result of the at least one processor 212. In an embodiment of the disclosure, the storage 218 may store data to be distributed from the server 200 to the electronic device 100. For example, the storage 218 may store at least one of one or more weights included in the AI model to be executed by the electronic device 100, one or more weighted matrices to be applied to the AI model, one or more weighted matrices of one or more adapters for fine-tuning the AI model, or one or more parameters used for fine-tuning the AI model.

The storage 218 may include one or more storage media. The storage 218 may include at least one of non-volatile memory or volatile memory. The at least one processor 212 may load data stored in the storage 218 into the memory 214 and process the data loaded into the memory 214.

The user interface 220 may include an input interface and/or an output interface for interaction with a user of the electronic device 100. For example, the user interface 220 may include an input interface that receives at least one of various inputs, such as a command, a request, information, or data, from the user of the electronic device 100. The input interface may include various input devices, such as a touch screen, a keyboard, and/or a microphone. The user interface 220 may include an output interface that provides, to the user, a result of performing an operation based on a user's command or a state of the electronic device 1000. The output interface may include various output devices, such as a display device and/or a speaker. In an embodiment of the disclosure, the electronic device 100 may obtain a user input from the user through the user interface 220. The electronic device 100 may perform a task indicated by the user input. The electronic device 100 may provide, to the user, a result of performing the task (e.g., a response to a question included in the user input, data edited according to a request from the user input, etc.) through the user interface 220.

In an embodiment of the disclosure, the electronic device 100 may communicate with the server 200, based on various wired or wireless communication protocols. The electronic device 100 may receive, from the server 200, one or more commands, program codes, and/or data structures to be executed (or driven) on the electronic device 100. For example, the server 200 may distribute, to the electronic device 100, at least one of a base model to be executed on the electronic device 100, one or more adapters for fine-tuning the base model with respect to a corresponding downstream task, one or more parameters used to combine the adapters, or one or more calibration parameters for calibrating (or adjusting or correcting) the combination of the adapters. The parameters or data distributed from the server 200 may be stored in the storage 218. The parameters or data distributed from the server 200 may be loaded into the memory 214 by the at least one processor 212 and may be processed, computed, and/or executed by the at least one processor 212.

In an embodiment of the disclosure, the server 200 may generate new adapters to be distributed to the electronic device 100. The server 200 may update existing adapters and/or existing parameters (e.g., weights used in a weighted average, or at least some of existing calibration parameters). The server 200 may distribute newly generated adapters, updated adapters, and/or updated parameters to the electronic device 100. The electronic device 100 may store the newly generated adapters, the updated adapters, and/or the updated parameters, which are received from the server 200, in the storage 218.

In an embodiment of the disclosure, the electronic device 100 may request the server 200 to perform at least some of the operations for generating an output corresponding to the user input. For example, the electronic device 100 may request the server 200 to perform at least some of operations 102, 106, 108, 110, and 112 of FIG. 1. The electronic device 100 may receive the result(s) of the operation(s) requested from the server 200. The electronic device 100 may provide the output corresponding to the user input, based on the received result(s).

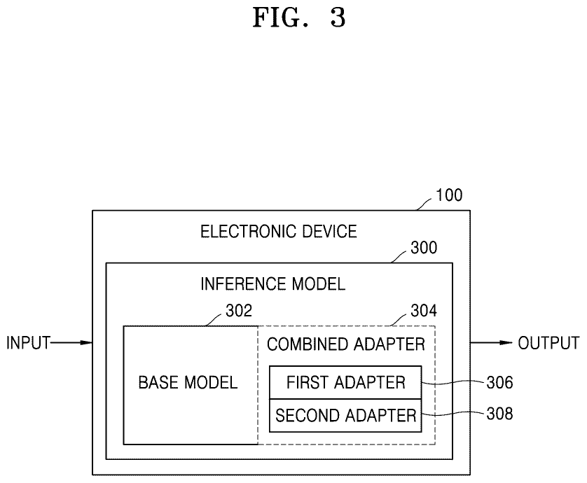

FIG. 3 illustrates an inference model 300 executed by an electronic device 100 according to an embodiment of the disclosure.

Referring to FIG. 3, the electronic device 100 may execute the inference model 300 so as to generate an output corresponding to a user input. The electronic device 100 may input the user input into the inference model 300. The inference model 300 may infer the output based on the user input. The inference model 300 may be implemented as an AI-based model.

The inference model 300 may be implemented based on a base model 302 and a combined adapter 304. For example, the inference model 300 may be obtained by merging the base model 302 with the combined adapter 304 or by applying the combined adapter 304 to the base model 302. The combined adapter 304 may correspond to a combination of a plurality of adapters. For example, the combined adapter 304 may refer to a combination of a first adapter 306 and a second adapter 308.

To perform a task indicated by the user input, the electronic device 100 may identify a task to achieve a goal of the user input. The electronic device 100 may identify the goal of the user input by analyzing the user input. The electronic device 100 may identify the task to be performed to achieve the goal of the user input. The electronic device 100 may identify whether the identified task is a combination of a plurality of downstream tasks (for example, whether the identified task is a compositional task). For example, the electronic device 100 may identify that the identified task is a combination of a first task (or a primary task) and a second task (or a secondary task). Accordingly, to perform the identified task, the electronic device 100 may combine the first adapter 306 specific for the first task with the second adapter 308 specific for the second task. By combining the first adapter 306 with the second adapter 308, the electronic device 100 may obtain the combined adapter 304 for performing the identified compositional task.

To perform the identified task, the electronic device 100 may apply the combined adapter 304 to the base model 302. For example, the electronic device 100 may obtain the inference model 300 by merging (or adding) the combined adapter 304 with (or to) the base model 302. Accordingly, the base model 302 may be fine-tuned to be specific for the identified compositional task (e.g., the combination of the first task and the second task). For example, the inference model 300 may correspond to the base model 302 that is fine-tuned to be specific for the compositional task of the first task and the second task.

In an embodiment of the disclosure, an adapter specific for a particular task may include one or more low-rank weighted matrices. Ranks of the weighted matrices of the adapter may be lower than a rank of the weighted matrix of the base model 302. For example, the weighted matrices of the base model 302 may have a size of 1 billion to 3 billion parameters, while the size of the adapter may be relatively small, such as 20 [MB] to 100 [MB]. Instead of fully retraining the base model 302, the electronic device 100 may fine-tune the base model 302 by using one or more adapters, so as to perform desired tasks.

In an embodiment of the disclosure, one adapter may include two factorized weighted matrices B∈ [symbol] and A∈ [symbol] (wherein rank r<<min(d, k)). Each of the weighted matrices may be obtained by training the adapter for the particular task. The weighted matrices of the adapter may be added to the weighted matrix W₀∈ [symbol] of the base model. During the training of the adapter, W₀ may be frozen, gradient update may not be received, and A and B may include learnable parameters. To obtain the output h corresponding to the input x, a forward pass may be modified as in Equation 1.

h=W₀x+ΔWx=W₀x+BAx [Equation 1]

In an embodiment of the disclosure, the first adapter 306 specific for the first task T₁ may include weighted matrices A₁ and B₁. The second adapter 308 specific for the second task T₂ may include weighted matrices A₂ and B₂. The electronic device 100 may merge the first adapter 306 with the second adapter 308, may calibrate the merged combined adapter 304 by using the calibration parameters P, and may merge the calibrated combined adapter 304 with the base model 302. For the compositional task W^{c} including the first task T₁ and the second task T₂ and the combining and calibrating function ƒ, the forward pass of the inference model 300 may be represented by Equation 2 (N may correspond to the number of adapters to be merged):

$$h = {W}_{0} x + Δ {W}^{c} x = {W}_{0} x + f ( P , {\{ {B}_{i} , {A}_{i} \}}_{i = 1}^{N} ) x = {W}_{0} x + f ( P , {B}_{2} , {A}_{2} , {B}_{1} , {A}_{1} ) x \qquad [ Equation 2 ]$$

In an embodiment of the disclosure, the calibration parameters P may be trained by using cross-entropy loss and data associated with the compositional task W^{c}. The training of the calibration parameters P is described in detail below.

In an embodiment of the disclosure, instead of performing inference using only the first adapter 306 and inference using only the second adapter 308, the electronic device 100 may perform inference using the inference model 300 obtained by merging the combined adapter 304 of the first adapter 306 and the second adapter 308 with the base model 302. Accordingly, the inference speed of the electronic device 100 may be improved.

In an embodiment of the disclosure, the first adapter 306 and the second adapter 308 may be merged by using any one of various model merging methods. For example, the first adapter 306 and the second adapter 308 may be merged by using any one of various model merging methods, such as linear merging, concatenation, trim, elect sign & merge (TIES-merging), drop and rescale (DARE) merging, spherical linear interpolation (Slerp) merging, LoRaHub, differentiable adaptive merging (DAM), and ZipLoRA merging. The combination and calibration of the adapters are described in detail below.

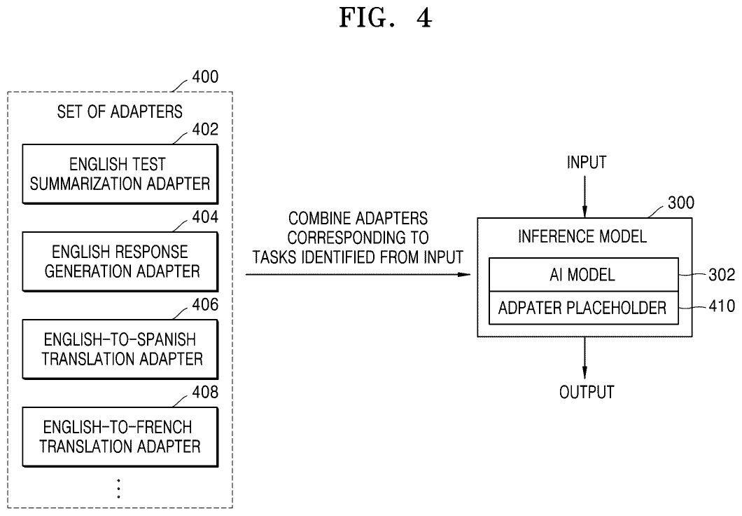

FIG. 4 illustrates a set of adapters 400 associated with an inference model 300 executed by the electronic device 100 according to an embodiment of the disclosure.

Referring to FIG. 4, the electronic device 100 may input a user input into the inference model 300. The inference model 300 may generate an output corresponding to the user input, based on the user input. The inference model 300 may include a base model 302 and a combined adapter of a plurality of adapters added to an adapter placeholder 410. The plurality of adapters to be added to the adapter placeholder 410 may be obtained from a set of adapters 400.

To generate the output corresponding to the user input, the electronic device 100 may identify a compositional task indicated by the user input. The electronic device 100 may identify the plurality of tasks included in the compositional task. The electronic device 100 may obtain, from the set of adapters 400, adapters for the plurality of tasks identified from the user input. The electronic device 100 may obtain a combined adapter by combining the obtained adapters. The electronic device 100 may calibrate the combined adapter and apply the calibrated combined adapter to the adapter placeholder 410. The electronic device 100 may obtain the inference model 300 by merging the calibrated combined adapter with the base model 302. By merging the calibrated combined adapter with the base model 302, the electronic device 100 may fine-tune the AI model with respect to the given compositional task.

The set of adapters 400 may include one or more adapters each specific for one or more downstream tasks supported by the electronic device 100. For example, in the embodiment of the disclosure illustrated in FIG. 4, the set of adapters 400 may include an adapter 402 trained to summarize English text, an adapter 404 trained to generate an English response, an adapter 406 trained to translate English to Spanish, and an adapter 406 trained to translate English to French. The respective adapters may be trained to be specific for the corresponding tasks. The electronic device 100 may select, from the set of adapters 400, an adapter corresponding to a task to be performed. As understood by one of ordinary skill in the art, the embodiments are not limited to these set of adaptors and may include any suitable adapter known to one of ordinary skill in the art.

In an embodiment of the disclosure, the set of adapters 400 may be stored in the electronic device 100. The electronic device 100 may select, from the set of adapters 400, adapters corresponding to the tasks identified from the user input and may combine the selected adapters to form a combined adapter. The electronic device 100 may merge the combined adapter with the base model 302 by applying the combined adapter to the adapter placeholder 410 and may obtain the inference model 300 accordingly.

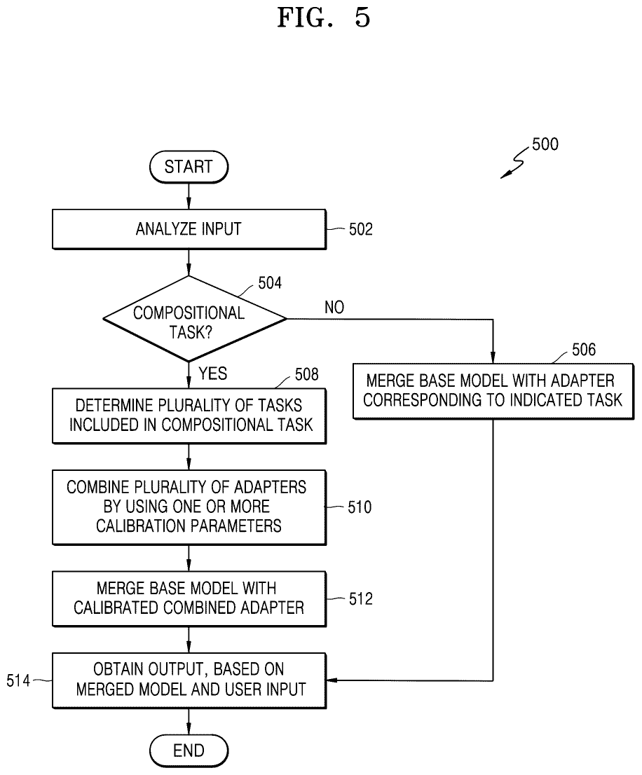

FIG. 5 illustrates a flowchart of a method 500 performed by the electronic device 100, according to an embodiment of the disclosure.

Referring to FIG. 5, the method 500 may include operations 502, 504, 506, 508, 510, 512, and 514. The method 500 may be performed by the electronic device 100. However, the disclosure is not limited thereto, and operations 502, 504, 506, 508, 510, 512, and 514 may be performed by an arbitrary electronic device individually or by a plurality of electronic devices collectively. The method 500 according to an embodiment of the disclosure is not limited to that illustrated in FIG. 5. The method 500 may omit any one of the operations illustrated in FIG. 5, or may further include operations not illustrated in FIG. 5. In an embodiment of the disclosure, the order of at least some of operations 502, 504, 506, 508, 510, 512, and 514 may be changed.

In operation 502, the electronic device 100 may analyze a user input. The electronic device 100 may identify a task indicated by the user input, based on the analysis of the user input. For example, the electronic device 100 may identify a goal of the user input. A task to achieve the goal of the user input may be identified. The electronic device 100 may identify the task to be performed to achieve the goal of the user input.

In operation 504, the electronic device 100 may identify whether the task indicated by the user input is a compositional task. For example, the electronic device 100 may identify whether to a plurality of tasks supported by the electronic device 100 have to be performed or whether a single task has to be performed, so as to perform the task indicated by the user input. Based on identifying that the plurality of tasks have to be performed so as to perform the task indicated by the user input, the electronic device 100 may identify that the task indicated by the user input is a compositional task. Based on identifying that the single task has to be performed so as to perform the task indicated by the user input, the electronic device 100 may identify that the task indicated by the user input is not a compositional task.

Based on identifying that the task indicated by the user input is not a compositional task, the electronic device 100 may perform operation 506. In operation 506, the electronic device 100 may merge a base model (e.g., the base model 302 of FIG. 3) with an adapter corresponding to the indicated task. For example, the electronic device 100 may obtain an adapter corresponding to the task indicated by the user input. The electronic device 100 may select, from the set of adapters 400, an adapter corresponding to the task indicated by the user input and may load the selected adapter. The electronic device 100 may apply the obtained adapter to the base model 302. The electronic device 100 may obtain a weighted matrix of the inference model for the task indicated by the user input, based on one or more weighted matrices of the obtained adapter and a weighted matrix of the base model. In an embodiment of the disclosure, the weighted matrix of the inference model for the task indicated by the user input may correspond to the sum of the one or more weighted matrices of the obtained adapter and the weighted matrix of the base model.

Based on identifying that the task indicated by the user input is a compositional task, the electronic device 100 may perform operation 508. In operation 508, the electronic device 100 may determine the plurality of tasks included in the compositional task. For example, the electronic device 100 may decompose the task indicated by the user input into a plurality of tasks.

In operation 510, the electronic device 100 may combine the plurality of adapters by using one or more calibration parameters. For example, the electronic device 100 may obtain a combined adapter by merging the adapters for each task included in the compositional task. The electronic device 100 may load, from an internal storage, the adapters for the plurality of tasks determined in operation 508. The electronic device 100 may receive, from an external electronic device, one or more of the adapters for the plurality of tasks determined in operation 508. The electronic device 100 may combine the plurality of obtained adapters.

In an embodiment of the disclosure, by computing a weighted average of the weighted matrices of the plurality of adapters, the electronic device 100 may obtain one or more weighted matrices of the combined adapter. The electronic device 100 may calibrate the combined adapter by using one or more calibration parameters. In an embodiment of the disclosure, the electronic device 100 may adjust one or more weights of the combined adapter by using one or more calibration parameters.

In operation 512, the electronic device 100 may merge the base model with the calibrated combined adapter. The electronic device 100 may apply the calibrated combined adapter to the base model. The electronic device 100 may obtain a weighted matrix of the inference model for the compositional task, based on one or more weighted matrices of the calibrated combined adapter and a weighted matrix of the base model. In an embodiment of the disclosure, the weighted matrix of the inference model for the compositional task may correspond to the sum of the one or more weighted matrices of the calibrated combined adapter and the weighted matrix of the base model.

In operation 514, the electronic device 100 may obtain an output, based on the merged model and the user input. The electronic device 100 may obtain the output corresponding to the user input by using the weighted matrix of the inference model obtained in operation 512 or the weighted matrix of the inference model obtained in operation 508. The electronic device 100 may provide the output obtained in operation 514 in response to the user input.

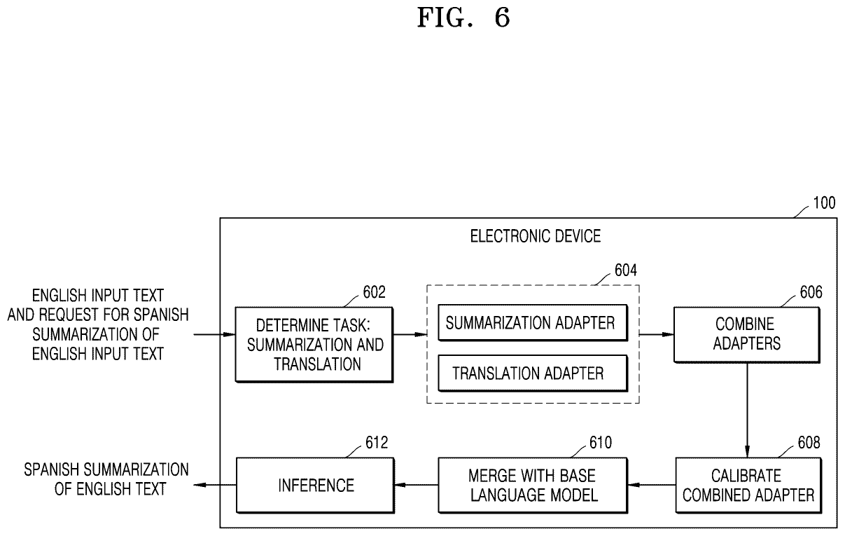

FIG. 6 illustrates operations performed by an electronic device 100 according to an embodiment of the disclosure.

Referring to FIG. 6, the electronic device 100 may perform operations 602, 606, 608, 610, and 612. However, the disclosure is not limited thereto, and operations 602, 606, 608, 610, and 612 may be performed by an arbitrary electronic device individually or by a plurality of electronic devices collectively. The electronic device 100 may omit any one of the operations illustrated in FIG. 6, and/or may additionally perform operations not illustrated in FIG. 6. In an embodiment of the disclosure, the order of at least some of operations 602, 606, 608, 610, and 612 may be changed.

The electronic device 100 may receive a user input including English input text and a request for a Spanish summarization of the English input text. In operation 602, the electronic device 100 may identify a compositional task indicated by the user input. The electronic device 100 may analyze the user input and identify (or determine) a task to achieve a goal indicated by the user input. The electronic device 100 may identify whether the identified task is the compositional task. In response to identifying that the identified task is a combination of a plurality of tasks supported by the electronic device 100, the electronic device 100 may identify that the identified task is the compositional task. The electronic device 100 may determine the plurality of tasks included in the compositional task. In one or more examples, a user input may be determined as a compositional task by inputting the user input into a LLM or learning model trained to identify a number of tasks included in the user input and trained to identify the types of tasks in the user input. For example, the electronic device 100 may input the user input to an LLM which is trained to identify a combination of one or more tasks to achieve the goal indicated by the user input, thereby identifying one or more tasks corresponding to the user input.

For example, the electronic device 100 may identify from the user input that the goal of the user input is to generate the Spanish summarization of the English input text. The electronic device 100 may identify that the task to be performed to achieve the goal of the user input is a combination of the summarization of the input text and the Spanish translation of the summarization. Accordingly, the electronic device 100 may identify that the identified task is a compositional task including the combination of the summarization of the input text and the Spanish translation of the summarization. The electronic device 100 may determine tasks to perform the summarization of the input text and the Spanish translation of the summarization.

In operation 606, the electronic device 100 may combine adapters 604 corresponding to tasks included in the compositional task identified in operation 602. For example, the electronic device 100 may combine a summarization adapter corresponding to the summarization of the input text and a translation adapter corresponding to the Spanish translation. In an embodiment of the disclosure, the electronic device 100 may load, from the storage, the summarization adapter and the translation adapter among the stored adapters. In an embodiment of the disclosure, the electronic device 100 may form a combined adapter by performing linear merging on the summarization adapter and the translation adapter. For example, the weights of the combined adapter may be obtained by computing a weighted average of the weights of the summarization adapter and the translation adapter. In an embodiment of the disclosure, the electronic device 100 may compute the weighted average by applying the same weights to the adapters or by applying defined (e.g., predefined or predetermined) weights to the respective adapters.

In operation 608, the electronic device 100 may calibrate the combined adapter. The electronic device 100 may calibrate the combined adapter by using one or more calibration parameters. In operation 608, the combined adapter may be calibrated to be specific for the compositional task identified in operation 602, for example, summarization of English text and Spanish translation. In an embodiment of the disclosure, the electronic device 100 may add the one or more calibration parameters to the combined adapter.

In operation 610, the electronic device 100 may merge the calibrated combined adapter with a pre-trained base language model. To generate an output corresponding to data in the form of a given text, the electronic device 100 may select a language model as the base model. By merging the calibrated combined adapter with the pre-trained base language model, the electronic device 100 may obtain an inference model specific for summarization of English text and Spanish translation.

In operation 612, the electronic device 100 may perform inference by using the inference model. The electronic device 100 may use the inference model specific for summarization of English text and Spanish translation, which is obtained in operation 610. By inputting a given English input text into the inference model, the electronic device 100 may obtain a Spanish summarization of the given English input text. For example, based on the given English input text, the inference model may generate the Spanish summarization of the given English input text. The electronic device 100 may provide the Spanish summarization generated by the inference model.

In the embodiment illustrated in FIG. 6, instead of performing first inference using the summarization adapter and the base language model and second inference using the translation adapter and the base language model, the electronic device 100 may perform one inference using the combined adapter, which is a combination of the summarization adapter and the translation adapter, and the base language model. Accordingly, the amount of computation performed in the electronic device 100 may be reduced, and the response speed to the user input may be improved.

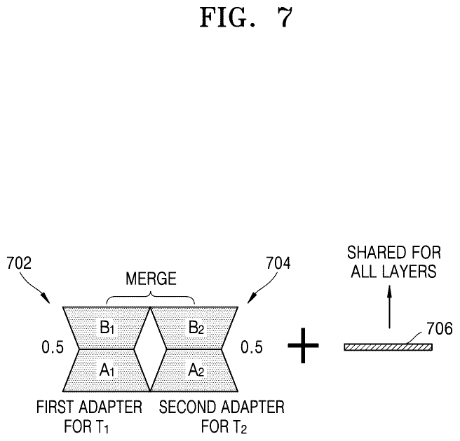

FIG. 7 illustrates combining adapters to form a combined adapter and calibrating the combined adapter, according to an embodiment of the disclosure.

Referring to FIG. 7, a first adapter 702 specific for a first task T₁ may include weighted matrices A₁ and B₁. A second adapter 704 specific for a second task T₂ may include weighted matrices A₂ and B₂. Calibration parameters P 706 may be shared for all layers. For example, the calibration parameters P 706 may be shared between layers of a base model into which a combined adapter is inserted.

The first adapter 702 and the second adapter 704 may be combined with each other by using linear merging. For example, the weighted matrices A′ and B′ of the combined adapter formed by merging the first adapter 702 with the second adapter 704 may be obtained based on Equation 3.

$${B}^{′} = \frac{1}{N} {\sum }_{i = 1}^{N} {B}_{i} = 0.5 {B}_{1} + 0.5 {B}_{2} , {A}^{′} = \frac{1}{N} {\sum }_{i = 1}^{N} {A}_{i} = 0.5 {A}_{1} + 0.5 {A}_{2} \qquad [ Equation 3 ]$$

In Equation 3, the weighted matrix A₁ of the first adapter 702 and the weighted matrix A₂ of the second adapter 704 may be linearly merged by using the same weight (e.g., 0.5). The weighted matrices Cambria Math and Cambria Math of the combined adapter may be calibrated by using the calibration parameters P 706. For a combined adapter matrix, column-wised biases p E [symbol] may be applied, as expressed in Equation 4.

$$Δ {W}^{c} = p ⊕ {B}^{′} {A}^{′} = p ⊕ Δ {W}^{′} = {\sum }_{i = 1}^{d} {p}_{i} Δ {W}_{i}^{′} \qquad [ Equation 4 ]$$

In Equation 4, the operation ⊕ may represent an element-by-column addition. Learnable biases p may be pre-trained. The biases p may be trained after being initialized to 0. For example, a vector (or set) of calibration parameters P 706 may be added to each column of a matrix B′A′. The calibration parameters P 706 may be formed as a column vector and may have a relatively small size, compared to the weighted matrices A₁, B₁, A₂, and B₂. Therefore, the electronic device 100 may store the calibration parameters in a small storage space.

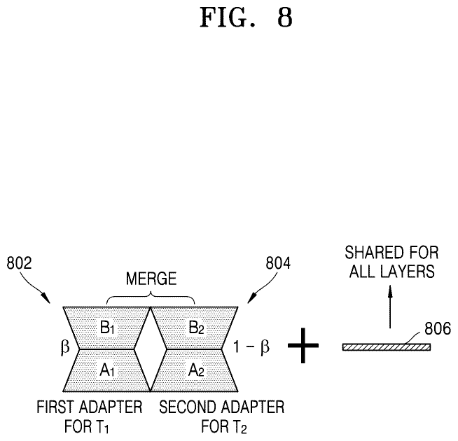

FIG. 8 illustrates combining adapters to form a combined adapter and calibrating the combined adapter, according to an embodiment of the disclosure.

Referring to FIG. 8, a first adapter 802 specific for a first task T₁ may include weighted matrices A₁ and B₁. A second adapter 804 specific for a second task T₂ may include weighted matrices A₂ and B₂. Calibration parameters P 806 may be shared for all layers. For example, the calibration parameters P 806 may be shared between layers of a base model into which a combined adapter is inserted.

The first adapter 802 and the second adapter 804 may be combined with each other by using linear merging. A weighted average may be computed by using different learnable weights for the first adapter 802 and the second adapter 804. For example, the weighted matrices A′ and B′ of the combined adapter formed by merging the first adapter 802 with the second adapter 804 may be obtained based on Equation 5.

B′=βB₁+(1−β)B₂,A′=βA₁+(1−β)A₂ [Equation 5]

In Equation 5, the weighted matrix A₁ of the first adapter 802 and the weighted matrix A₂ of the second adapter 804 may be linearly merged by using different weights. β may be a learnable parameter. β may be optimized together with training of the calibration parameters P 806. One weight β may be present for each component, or β may be shared for all layers. For example, β used for a compositional task

$${W}_{1 , 2}^{C} ,$$

which is a combination of the first task T₁ and the second task T₂, may also be applied to other compositional tasks. In one or more examples, a weight β may be trained for each compositional task. The weight β applied to each compositional task may be different. β used to combine adapters for a particular layer of a base model may also be used for other layers. In one or more examples, the weight β may be trained for each of the base model.

The weighted matrices A′ and B′ of the combined adapter obtained through Equation 5 may be calibrated by using the calibration parameters P 806. For example, the weighted matrices A′ and B′ of the combined adapter may be calibrated based on Equation 4, or may be calibrated as in the following embodiment of the disclosure illustrated in FIG. 8.

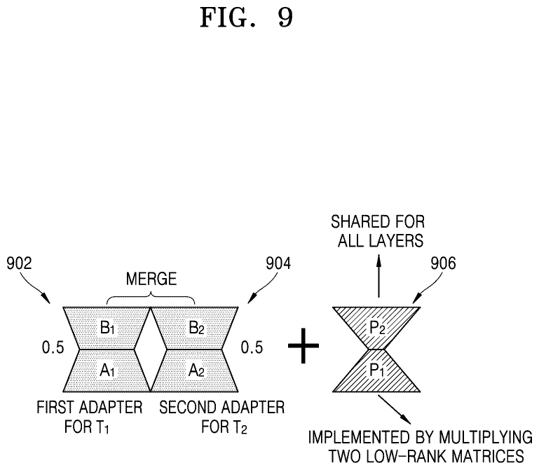

FIG. 9 illustrates combining adapters to form a combined adapter and calibrating the combined adapter, according to an embodiment of the disclosure.

Referring to FIG. 9, a first adapter 902 specific for a first task T₁ may include weighted matrices A₁ and B₁. A second adapter 904 specific for a second task T₂ may include weighted matrices A₂ and B₂. A calibration matrix 906 may include two low-rank matrices P₂ ∈ [symbol] and P₁∈ [symbol] (wherein rank s<<min (d, k)). The calibration matrix 906 may be shared for all layers. For example, the calibration matrix 906 may be shared between layers of a base model into which a combined adapter is inserted.

The first adapter 902 and the second adapter 904 may be combined with each other by using linear merging. For example, the weighted matrices A′ and B′ of the combined adapter formed by merging the first adapter 902 and the second adapter 904 may be obtained based on Equation 3. In one or more examples, the weighted matrices A′ and B′ of the combined adapter may be obtained based on Equation 5. The calibration matrix 906 may be added to top of a reconstructed combined adapter, which may result in a full matrix update as in Equation 6:

ΔW^{c}=P₂P₁+ΔW′=P₂P₁+B′A′ [Equation 6]

The calibration matrix 906 may be implemented by multiplying two low-rank matrices P₁ and P₂. In contrast to the combined adapter, the calibration matrix 906 may be shared for all layers of the base model. Unlike calibration parameters implemented as a column bias vectors or a row bias vector, the calibration matrix 906 may include more parameters. Accordingly, a calibration effect may be improved.

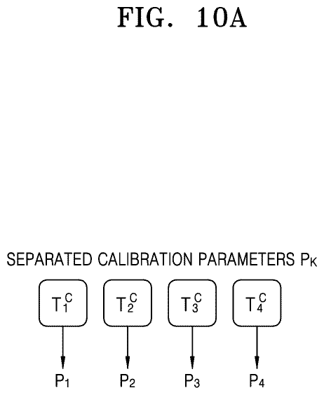

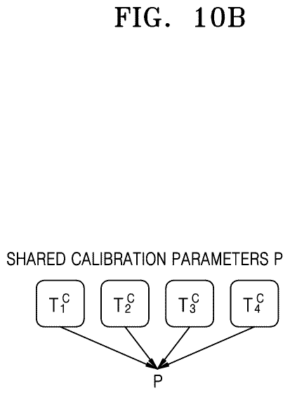

FIG. 10A illustrates calibration parameters according to an embodiment of the disclosure.

Referring to FIG. 10A, one or more calibration parameters may be trained for each compositional task. For example, calibration parameters P₁ may be trained for a first compositional task

$${T}_{1}^{C} .$$

Calibration parameters P₂ may be trained for a second compositional task

$${T}_{2}^{C} .$$

Calibration parameters P₃ may be trained for a third compositional task

$${T}_{3}^{C} .$$

Calibration parameters P₄ may be trained for a fourth compositional task

$${T}_{4}^{C} .$$

Because the calibration parameters are separately optimized for each compositional task, the performance of calibration of the combined adapter for each compositional task may be improved.

For example, to generate a response to a user input, the electronic device 100 may identify, from the user input, the first compositional task

$${T}_{1}^{C}$$

including a first task and a second task. The electronic device 100 may load a first adapter corresponding to the first task and a second adapter corresponding to the second task. Based on the calibration parameters P₁ for the first compositional task

$${T}_{1}^{C} ,$$

the electronic device 100 may reconstruct the combined adapter for the first compositional task

$${T}_{1}^{C}$$

from the first adapter and the second adapter. The electronic device 100 may obtain an inference model for the first compositional task

$${T}_{1}^{C}$$

by merging the base model with the combined adapter for the first compositional task

$${T}_{1}^{C} .$$

For example, the electronic device 100 may load one or more weighted matrices of the base model stored in the storage 218, and may merge at least one of the loaded weighted matrices with one or more weighted matrices of the combined adapter for the first compositional task

$${T}_{1}^{C} .$$

The electronic device 100 may generate a response to a given user input by using the inference model for the first compositional task

$${T}_{1}^{C} .$$

Thereafter, the electronic device 100 may receive a new additional user input. To generate an additional response to the additional user input, the electronic device 100 may identify, from the additional user input, the second compositional task

$${T}_{2}^{C}$$

including a third task and a fourth task. The electronic device 100 may load a third adapter corresponding to the third task and a fourth adapter corresponding to the fourth task. Based on the calibration parameters P₂ for the second compositional task

$${T}_{2}^{C} ,$$

the electronic device 100 may reconstruct the combined adapter for the second compositional task

$${T}_{2}^{C}$$

from the third adapter and the fourth adapter. The electronic device 100 may obtain an inference model for the second compositional task

$${T}_{2}^{C}$$

by merging the base model with the combined adapter for the second compositional task

$${T}_{2}^{C} .$$

For example, the electronic device 100 may reload one or more weighted matrices of the base model stored in the storage 218, and may merge at least one of the loaded weighted matrices with at least one of one or more weighted matrices of the combined adapter for the second compositional task

$${T}_{2}^{C} .$$

In one or more examples, the electronic device 100 may subtract the weighted matrices corresponding to the combined adapter for the first compositional task

$${T}_{1}^{C}$$

from the inference model for the first compositional task

$${T}_{1}^{C} ,$$

and may add at least one of the one or more weighted matrices of the combined adapter for the second compositional task

$${T}_{2}^{C} .$$

The electronic device 100 may generate a response to a given user input by using the inference model for the second compositional task

$${T}_{2}^{C} .$$

FIG. 10B illustrates calibration parameters according to an embodiment of the disclosure.

Referring to FIG. 10B, the calibration parameters may be shared between the compositional tasks. For example, calibration parameters P may be trained for a first compositional task

$${T}_{1}^{C} ,$$

a second compositional task

$${T}_{2}^{C} ,$$

a third compositional task

$${T}_{3}^{C} ,$$

and a fourth compositional task

$${T}_{4}^{C} .$$

By sharing the calibration parameters P between all compositional tasks, a less storage space may be used for storing the calibration parameters P.

For example, to generate a response to a user input, the electronic device 100 may identify, from the user input, the first compositional task

$${T}_{1}^{C}$$

Including a first task and a second task. The electronic device 100 may load a first adapter corresponding to the first task and a second adapter corresponding to the second task. Based on the calibration parameters P, the electronic device 100 may reconstruct the combined adapter for the first compositional task

$${T}_{1}^{C}$$

from the mist adapter and the second adapter. The electronic device 100 may generate a response to the user input by using the reconstructed combined adapter for the first compositional task

$${T}_{1}^{C} .$$

Thereafter, the electronic device 100 may receive a new additional user input. To generate an additional response to the additional user input, the electronic device 100 may identify, from the additional user input, the second compositional task

$${T}_{2}^{C}$$

including a third task and a fourth task. The electronic device 100 may load a third adapter corresponding to the third task and a fourth adapter corresponding to the fourth task. Based on the calibration parameters P used for the first compositional task

$${T}_{1}^{C} ,$$

the electronic device 100 may reconstruct the combined adapter for the second compositional task

$${T}_{2}^{C}$$

from the third adapter and the fourth adapter. The electronic device 100 may generate an additional response to the additional user input by using the reconstructed combined adapter for the second compositional task

$${T}_{2}^{C} .$$

FIG. 11 illustrates a flowchart of a method 1100, performed by the server 200, of training calibration parameters, according to an embodiment of the disclosure.

Referring to FIG. 11, the method 1100 may include operations 1102, 1104, 1106, 1108 1110, and 1112. The method 1100 may be performed by the server 200. However, the disclosure is not limited thereto, and operations 1102, 1104, 1106, 1108 1110, and 1112 may be performed by an arbitrary electronic device individually or by a plurality of electronic devices collectively. The method 1100 according to an embodiment of the disclosure is not limited to that illustrated in FIG. 11. The method 1100 may omit any one of the operations illustrated in FIG. 11, or may further include operations not illustrated in FIG. 11. In an embodiment of the disclosure, the order of at least some of operations 1102, 1104, 1106, 1108 1110, and 1112 may be changed.

In an embodiment of the disclosure, the method 1100 may be performed by using training examples (or training data) from given training steps T, a learning rate, a base model (e.g., a base AI model or a foundation model), single-task adapters, and a compositional task. The method 1100 may be performed prior to distributing the base model to the electronic device 100.

In operation 1102, the server 200 may initialize calibration parameters P and a step t. For example, the server 200 may initialize the calibration parameters P and the step t to 0. In operation 1104, the server 200 may identify whether the current step t is identical to a given training step T. The server 200 may terminate the training of the calibration parameters P, based on identifying that the current step t is identical to the given training step T. The server 200 may perform operation 1106, based on identifying that the current step t is not identical to the given training step T.

In operation 1106, the server 200 may calibrate a combined adapter by using the calibration parameters P. For example, the server 200 may obtain a combined adapter by combining single-task adapters for a particular compositional task, and may calibrate the combined adapter by using the calibration parameters P. Accordingly, the single-task adapters may be transformed into the calibrated combined adapter. In operation 1108, the server 200 may merge the calibrated combined adapter with the base model. Accordingly, a merged model adapted to the particular compositional task may be obtained.

In operation 1110, the server 200 may obtain predictions by inputting one or more training samples into the merged model. For example, the server 200 may sample one or more examples from training data associated with the compositional task. Each of the one or more examples may include input training data and output training data corresponding to a result of performing a compositional task on the input training data. The server 200 may input the obtained examples (or training samples) into the merged model. The merged model may generate predictions in response to the training examples or the training samples.

In operation 1112, the server 200 may update the calibration parameters P through back-propagation. The server 200 may calculate a loss function based on the predictions generated by the merged model and the output training data included in the training data. The server 200 may update the calibration parameters P through back-propagation, based on the calculated loss function. For example, during the back-propagation, the weighted matrices of the base model and the combined adapter may be frozen, and only the calibration parameters P may be updated. In an embodiment of the disclosure, the loss function may be based on cross-entropy loss. The server 200 may increment the training step t by 1 and then perform operation 1104 again.

In an embodiment of the disclosure, the base model may be a language model (or a large language model). Accordingly, the model in which the base model and the combined adapter are merged may generate next-token predictions for input data (e.g., text data) of given training examples. The loss function may be computed by comparing the next-token predictions with the output data (e.g., text data) of the given training examples. The calibration parameters P may be updated through back-propagation, based on the loss function.

In an embodiment of the disclosure, calibration parameters P may be updated for a plurality of compositional tasks. After performing the method 1100 on the first compositional task, the server 200 may at least partially perform the method 1100 on the second compositional task. For example, for the second compositional task, in operation 1102, the server 200 may initialize only the training step t without initializing the calibration parameters P. For the second compositional task, in operation 1106, the server 200 may combine and calibrate adapters for a plurality of tasks included in the second compositional task by using the calibration parameters P. For the second compositional task, in operation 1108, the server 200 may merge the calibrated combined adapter with the base model. For the second compositional task, in operation 1110, the server 200 may obtain a prediction by inputting one or more training samples associated with the second compositional task into the merged model. For the second compositional task, in operation 1112, the server 200 may update the calibration parameters P through back-propagation. Accordingly, the calibration parameters P may be updated for the plurality of compositional tasks.

In an embodiment of the disclosure, the method 1100 may be performed on at least some of all possible combinations of downstream tasks supported by the electronic device 100. For example, based on three downstream tasks T_{A}, T_{B}, and T_{C} supported by the electronic device 100, the server 200 may perform the method 1100 on at least some of a compositional task

$${T}_{A , B}^{C}$$

Including a combination of tasks T_{A} and T_{B}, a compositional task

$${T}_{B , C}^{C}$$

Including a combination of tasks T_{B} and T_{C}, and a compositional task

$${T}_{A , B , C}^{C}$$

including a combination of tasks T_{A} and T_{B}, T_{C}. Accordingly, the calibration parameters P may be updated for the plurality of compositional tasks to be performed by the electronic device 100.

In an embodiment of the disclosure, for the plurality of compositional tasks

$${T}_{1}^{C} to {T}_{k}^{C} ,$$

a plurality or sets of calibration parameters P₁ to Pₖ may be trained independently. For example, the calibration parameters P₁ may be trained for the first compositional task

$${T}_{1}^{C} .$$

The calibration parameters P₂ may be trained for the second compositional task

$${T}_{2}^{C} .$$

The calibration parameters P₃ may be trained for the third compositional task

$${T}_{3}^{C} .$$

The calibration parameters P₄ may be trained for the fourth compositional task

$${T}_{4}^{C} .$$

In an embodiment of the disclosure, the training of the calibration parameters P and the on-device fine-tuning based on the calibration parameters P may be performed based on an algorithm described in Table 1.

```
TABLE 1
  Input: single-task adapters already stored in device, base model (e.g.,
LLM), dataset of examples from compositional task (inputs x - e.g., long
texts, outputs y - e.g., translated summaries).
  Initialize calibration parameters P to 0 (no effect) and insert them to
base model.
  During training:
    Sample new mini-batch of examples from compositional task.
    Use base model together with calibration parameters P on mini-batch
of given examples and compute loss.
    Update calibration parameters P through back-propagation
  During distribution:
    Load relevant single-task adapters, average them, and transform them
through P to obtain overall updated weights.
```

In an embodiment of the disclosure, while the method 1100 is performed, the weights β used for merging single-task adapters may be trained together. For example, in operation 1102, the server 200 may additionally initialize the weight β to 0.5. In operation 1106, the server 200 may combine adapters based on Equation 5. In operation 1112, the server 200 may additionally update the weight β through back-propagation.

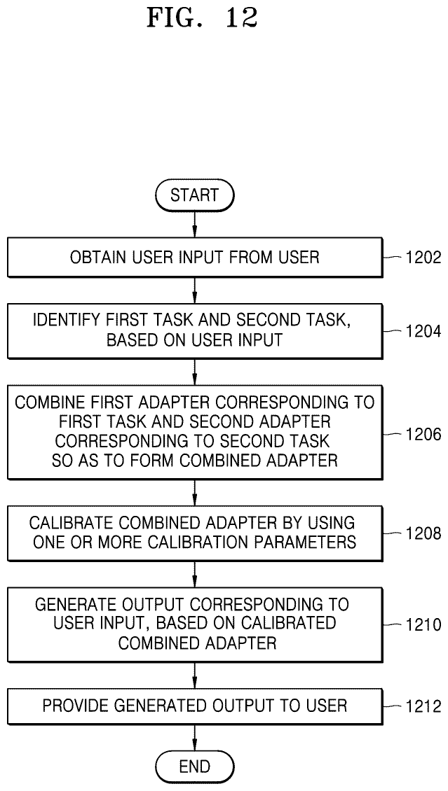

FIG. 12 illustrates a flowchart of a method 1200 performed by the electronic device 100, according to an embodiment of the disclosure.

Referring to FIG. 12, the method 1200 may include operations 1202, 1204, 1206, 1208, 1210, 1212, and 1214. The method 1200 may be performed by the electronic device 100. However, the disclosure is not limited thereto, and operations 1202, 1204, 1206, 1208, 1210, 1212, and 1214 may be performed by an arbitrary electronic device individually or by a plurality of electronic devices collectively. The method 1200 according to an embodiment of the disclosure is not limited to that illustrated in FIG. 12. The method 1200 may omit any one of the operations illustrated in FIG. 12, or may further include operations not illustrated in FIG. 12. In an embodiment of the disclosure, the order of at least some of operations 1202, 1204 1206, 1208, 1210, 1212, and 1214 may be changed.

In operation 1202, the electronic device 100 may obtain a user input from a user. In operation 1204, the electronic device 100 may identify a first task and a second task, based on the obtained user input. In operation 1206, the electronic device 100 may obtain a first adapter corresponding to the first task and a second adapter corresponding to the second task. In operation 1206, the electronic device 100 may combine the first adapter with the second adapter to form a combined adapter. In operation 1208, the electronic device 100 may calibrate the combined adapter by using one or more calibration parameters. In operation 1210, the electronic device 100 may generate an output corresponding to the user input, based on the calibrated combined adapter. In operation 1212, the electronic device 100 may provide the generated output to a user.

In one or more examples, to identify the first task and the second task, the electronic device 100 may identify a goal of the user input. The electronic device 100 may identify the task to achieve the goal of the user input. The electronic device 100 may identify a plurality of tasks included in the identified task and including the first task and the second task.

In one or more examples, to combine the first adapter with the second adapter, the electronic device 100 may compute a weighted average of a weighted matrix of the first adapter and a weighted matrix of the second adapter. The electronic device 100 may obtain the combined adapter, based on the computed weighted average. In an embodiment of the disclosure, to compute the weighted average, the weighted matrix of the first adapter and the weighted matrix of the second adapter may be weighted by the same weights. In an embodiment of the disclosure, to compute the weighted average, the weighted matrix of the first adapter and the weighted matrix of the second adapter may be weighted by weights respectively defined with respect to the first and second adapters.

In one or more examples, to calibrate the combined adapter by using one or more calibration parameters, the electronic device 100 may add a set of column-wised parameters including one or more calibration parameters and one or more weights of a weighted matrix of the combined adapter. In one or more examples, to calibrate the combined adapter by using one or more calibration parameters, the electronic device 100 may add a pair of a first calibration matrix including a first set of one or more calibration parameters and a second calibration matrix including a second set of one or more calibration parameters to a pair of a first weighted matrix and a second weighted matrix of the combined adapter.

In one or more examples, the electronic device 100 may obtain a pre-trained base model to generate an output corresponding to the user input, based on the calibrated combined adapter. The electronic device 100 may obtain an inference model by merging one or more weighted matrices of the calibrated combined adapter with a weighted matrix of the base model. The electronic device 100 may obtain the output by inputting the user input into the inference model. In one or more examples, ranks of one or more weighted matrices of the first adapter and one or more weighted matrices of the second adapter may be lower than a rank of the weighted matrix of the base model.

In one or more examples, the electronic device 100 may obtain an additional user input from the user. The electronic device 100 may identify a third task and a fourth task corresponding to the additional user input. The electronic device 100 may obtain a third adapter corresponding to the third task and a fourth adapter corresponding to the fourth task. The electronic device 100 may combine the third adapter with the fourth adapter to form an additional combined adapter. The electronic device 100 may calibrate the additional combined adapter by using the one or more calibration parameters. The electronic device 100 may generate an additional output corresponding to the additional user input, based on the calibrated additional combined adapter. The electronic device 100 may provide the additional output to the user.

In one or more examples, the electronic device 100 may obtain an additional user input from the user. The electronic device 100 may identify a third task and a fourth task corresponding to the additional user input. The electronic device 100 may obtain a third adapter corresponding to the third task and a fourth adapter corresponding to the fourth task. The electronic device 100 may combine the third adapter with the fourth adapter to form an additional combined adapter. The electronic device 100 may calibrate the additional combined adapter by using one or more additional calibration parameters corresponding to a combination of the third task and the fourth task. The electronic device 100 may generate an additional output corresponding to the additional user input, based on the calibrated additional combined adapter. The electronic device 100 may provide the additional output to the user.

A machine-readable storage medium may be provided in the form of a non-transitory storage medium. The ‘non-transitory storage medium’ is a tangible device and only means not including a signal (e.g., electromagnetic waves). This term does not distinguish between a case where data is semi-permanently stored in a storage medium and a case where data is temporarily stored in a storage medium. For example, the ‘non-transitory storage medium’ may include a buffer in which data is temporarily stored.

A method according to an embodiment of the disclosure may be provided by being included in a computer program product. The computer program product may be traded between a seller and a buyer as commodities. The computer program product may be distributed in the form of a machine-readable storage medium (e.g., compact disc read-only memory (CD-ROM)), or may be distributed (e.g., downloaded or uploaded) online either via an application store or directly between two user devices (e.g., smartphones). In the case of the online distribution, at least a part of a computer program product (e.g., downloadable app) is stored at least temporarily on a machine-readable storage medium, such as a server of a manufacturer, a server of an application store, or memory of a relay server, or may be temporarily generated.

According to an aspect of the disclosure, a method includes: obtaining a user input from a user; identifying, based on the user input, a first task and a second task; combining a first adapter corresponding to the first task with a second adapter corresponding to the second task to generate a combined adapter; calibrating the combined adapter by using one or more calibration parameters; generating an output corresponding to the user input, based on the calibrated combined adapter; and providing the generated output to the user.

According to an aspect of the disclosure, the identifying of the first task and the second task includes: identifying a goal of the user input; identifying a task to achieve the goal of the user input; and identifying a plurality of tasks included in the identified task, the plurality of tasks comprising the first task and the second task.

According to an aspect of the disclosure, the combining of the first adapter with the second adapter includes computing a weighted average of a weighted matrix of the first adapter and a weighted matrix of the second adapter.

According to an aspect of the disclosure, to compute the weighted average, the weighted matrix of the first adapter and the weighted matrix of the second adapter are weighted by (i) same weights or (ii) a first set of weights for the first adapter and a second set of weights for the second adapter.

According to an aspect of the disclosure, the calibrating of the combined adapter by using the one or more calibration parameters includes adding a set of column-wise parameters comprising the one or more calibration parameters and one or more weights of a weighted matrix of the combined adapter.

According to an aspect of the disclosure, the calibrating of the combined adapter by using the one or more calibration parameters includes adding a pair of a first calibration matrix comprising a first set of the one or more calibration parameters and a second calibration matrix comprising a second set of the one or more calibration parameters to a pair of a first weighted matrix and a second weighted matrix of the combined adapter.

According to an aspect of the disclosure, the generating of the output corresponding to the user input, based on the calibrated combined adapter, includes: obtaining a pre-trained base model; obtaining an inference model by merging one or more weighted matrices of the calibrated combined adapter with a weighted matrix of the pre-trained base model; and obtaining the output by inputting the user input into the inference model.

According to an aspect of the disclosure, a first rank of one or more weighted matrices of the first adapter and a second rank one or more weighted matrices of the second adapter are lower than a third rank of the weighted matrix of the pre-trained base model.

According to an aspect of the disclosure, the method further includes: obtaining an additional user input from the user; identifying a third task and a fourth task, each corresponding to the additional user input; combining a third adapter corresponding to the third task with a fourth adapter corresponding to the fourth task to generate an additional combined adapter; calibrating the additional combined adapter by using the one or more calibration parameters; generating an additional output corresponding to the additional user input, based on the calibrated additional combined adapter; and providing the additional output to the user.

According to an aspect of the disclosure, the method further includes: obtaining an additional user input from the user; identifying a third task and a fourth task, each corresponding to the additional user input; combining a third adapter corresponding to the third task with a fourth adapter corresponding to the fourth task to generate an additional combined adapter; calibrating the additional combined adapter by using one or more additional calibration parameters corresponding to a combination of the third task and the fourth task; generating an additional output corresponding to the additional user input, based on the calibrated additional combined adapter; and providing the additional output to the user.

According to an aspect of the disclosure, a non-transitory computer-readable recording medium having instructions stored therein, which when executed by a computer, cause the computer to perform a method including: obtaining a user input from a user; identifying, based on the user input, a first task and a second task; combining a first adapter corresponding to the first task with a second adapter corresponding to the second task to generate a combined adapter; calibrating the combined adapter by using one or more calibration parameters; generating an output corresponding to the user input, based on the calibrated combined adapter; and providing the generated output to the user.

According to an aspect of the disclosure, an electronic device includes: memory storing instructions; and at least one processor operatively coupled to the memory and comprising processing circuitry, wherein the instructions, when executed by the at least one processor individually or collectively, cause the electronic device to: obtain a user input from a user; identify a first task and a second task, based on the user input; combine a first adapter corresponding to the first task with a second adapter corresponding to the second task to generate a combined adapter; calibrate the combined adapter by using one or more calibration parameters; generate an output corresponding to the user input, based on the calibrated combined adapter; and provide the generated output to the user.

According to an aspect of the disclosure, the instructions, when executed by the at least one processor individually or collectively, further cause the electronic device to: identify a goal of the user input; identify a task to achieve the goal of the user input; and identify a plurality of tasks included in the identified task, the plurality of tasks comprising the first task and the second task.

According to an aspect of the disclosure, the instructions, when executed by the at least one processor individually or collectively, further cause the electronic device to compute a weighted average of a weighted matrix of the first adapter and a weighted matrix of the second adapter.

According to an aspect of the disclosure, to compute the weighted average, the weighted matrix of the first adapter and the weighted matrix of the second adapter are weighted by (i) same weights or (ii) a first set of weights for the first adapter and a second set of weights for the second adapter.

According to an aspect of the disclosure, the instructions, when executed by the at least one processor individually or collectively, further cause the electronic device to add a set of column-wise parameters including the one or more calibration parameters and one or more weights of a weighted matrix of the combined adapter.

According to an aspect of the disclosure, the instructions, when executed by the at least one processor individually or collectively, further cause the electronic device to add a pair of a first calibration matrix comprising a first set of the one or more calibration parameters and a second calibration matrix comprising a second set of the one or more calibration parameters to a pair of a first weighted matrix and a second weighted matrix of the combined adapter.

According to an aspect of the disclosure, the instructions, when executed by the at least one processor individually or collectively, further cause the electronic device to: obtain a pre-trained base model; obtain an inference model by merging one or more weighted matrices of the calibrated combined adapter with a weighted matrix of the base model; and obtain the output by inputting the user input into the inference model.

According to an aspect of the disclosure, the instructions, when executed by the at least one processor individually or collectively, further cause the electronic device to: obtain an additional user input from the user; identify a third task and a fourth task, each corresponding to the additional user input; combine a third adapter corresponding to the third task with a fourth adapter corresponding to the fourth task so as to form an additional combined adapter; calibrate the additional combined adapter by using the one or more calibration parameters; generate an additional output corresponding to the additional user input, based on the calibrated additional combined adapter; and provide the additional output to the user.

According to an aspect of the disclosure, the instructions, when executed by the at least one processor individually or collectively, further cause the electronic device to: obtain an additional user input from the user; identify a third task and a fourth task, each corresponding to the additional user input; combine a third adapter corresponding to the third task with a fourth adapter corresponding to the fourth task so as to form an additional combined adapter; calibrate the additional combined adapter by using one or more additional calibration parameters corresponding to a combination of the third task and the fourth task; generate an additional output corresponding to the additional user input, based on the calibrated additional combined adapter; and provide the additional output to the user.

As described above, although the embodiments of the disclosure have been described with reference to the restrictive embodiments of the disclosure and drawings, various modifications and variations may be made thereto from the above description by those of ordinary skill in the art. For example, appropriate results may be achieved even when the technologies described above are performed in an order different from the methods described above, and/or components of the computer system or modules described above are coupled or combined in a manner different from the methods described above or are replaced or substituted by other components or equivalents.

1. A method comprising:
obtaining a user input from a user;
identifying, based on the user input, a first task and a second task;
combining a first adapter corresponding to the first task with a second adapter corresponding to the second task to generate a combined adapter;
calibrating the combined adapter by using one or more calibration parameters;
generating an output corresponding to the user input, based on the calibrated combined adapter; and
providing the generated output to the user.

2. The method of claim 1, wherein the identifying of the first task and the second task comprises:
identifying a goal of the user input;
identifying a task to achieve the goal of the user input; and
identifying a plurality of tasks included in the identified task, the plurality of tasks comprising the first task and the second task.

3. The method of claim 1, wherein the combining of the first adapter with the second adapter comprises computing a weighted average of a weighted matrix of the first adapter and a weighted matrix of the second adapter.

4. The method of claim 3, wherein, to compute the weighted average, the weighted matrix of the first adapter and the weighted matrix of the second adapter are weighted by (i) same weights or (ii) a first set of weights for the first adapter and a second set of weights for the second adapter.

5. The method of claim 1, wherein the calibrating of the combined adapter by using the one or more calibration parameters comprises adding a set of column-wise parameters comprising the one or more calibration parameters and one or more weights of a weighted matrix of the combined adapter.

6. The method of claim 1, wherein the calibrating of the combined adapter by using the one or more calibration parameters comprises adding a pair of a first calibration matrix comprising a first set of the one or more calibration parameters and a second calibration matrix comprising a second set of the one or more calibration parameters to a pair of a first weighted matrix and a second weighted matrix of the combined adapter.

7. The method of claim 1, wherein the generating of the output corresponding to the user input, based on the calibrated combined adapter, comprises:
obtaining a pre-trained base model;
obtaining an inference model by merging one or more weighted matrices of the calibrated combined adapter with a weighted matrix of the pre-trained base model; and
obtaining the output by inputting the user input into the inference model.

8. The method of claim 7, wherein a first rank of one or more weighted matrices of the first adapter and a second rank one or more weighted matrices of the second adapter are lower than a third rank of the weighted matrix of the pre-trained base model.

9. The method of claim 1, further comprising:
obtaining an additional user input from the user;
identifying a third task and a fourth task, each corresponding to the additional user input;
combining a third adapter corresponding to the third task with a fourth adapter corresponding to the fourth task to generate an additional combined adapter;
calibrating the additional combined adapter by using the one or more calibration parameters;
generating an additional output corresponding to the additional user input, based on the calibrated additional combined adapter; and
providing the additional output to the user.

10. The method of claim 1, further comprising:
obtaining an additional user input from the user;
identifying a third task and a fourth task, each corresponding to the additional user input;
combining a third adapter corresponding to the third task with a fourth adapter corresponding to the fourth task to generate an additional combined adapter;
calibrating the additional combined adapter by using one or more additional calibration parameters corresponding to a combination of the third task and the fourth task;
generating an additional output corresponding to the additional user input, based on the calibrated additional combined adapter; and
providing the additional output to the user.

11. A non-transitory computer-readable recording medium having instructions stored therein, which when executed by a computer, cause the computer to perform a method comprising:
obtaining a user input from a user;
identifying, based on the user input, a first task and a second task;
combining a first adapter corresponding to the first task with a second adapter corresponding to the second task to generate a combined adapter;
calibrating the combined adapter by using one or more calibration parameters;
generating an output corresponding to the user input, based on the calibrated combined adapter; and
providing the generated output to the user.

12. An electronic device comprising:
memory storing instructions; and
at least one processor operatively coupled to the memory and comprising processing circuitry,
wherein the instructions, when executed by the at least one processor individually or collectively, cause the electronic device to:
obtain a user input from a user;
identify a first task and a second task, based on the user input;
combine a first adapter corresponding to the first task with a second adapter corresponding to the second task to generate a combined adapter;
calibrate the combined adapter by using one or more calibration parameters;
generate an output corresponding to the user input, based on the calibrated combined adapter; and
provide the generated output to the user.

13. The electronic device of claim 12, wherein the instructions, when executed by the at least one processor individually or collectively, further cause the electronic device to:
identify a goal of the user input;
identify a task to achieve the goal of the user input; and
identify a plurality of tasks included in the identified task, the plurality of tasks comprising the first task and the second task.

14. The electronic device of claim 12, wherein the instructions, when executed by the at least one processor individually or collectively, further cause the electronic device to compute a weighted average of a weighted matrix of the first adapter and a weighted matrix of the second adapter.

15. The electronic device of claim 14, wherein, to compute the weighted average, the weighted matrix of the first adapter and the weighted matrix of the second adapter are weighted by (i) same weights or (ii) a first set of weights for the first adapter and a second set of weights for the second adapter.

16. The electronic device of claim 12, wherein the instructions, when executed by the at least one processor individually or collectively, further cause the electronic device to add a set of column-wise parameters comprising the one or more calibration parameters and one or more weights of a weighted matrix of the combined adapter.

17. The electronic device of claim 12, wherein the instructions, when executed by the at least one processor individually or collectively, further cause the electronic device to add a pair of a first calibration matrix comprising a first set of the one or more calibration parameters and a second calibration matrix comprising a second set of the one or more calibration parameters to a pair of a first weighted matrix and a second weighted matrix of the combined adapter.

18. The electronic device of claim 12, wherein the instructions, when executed by the at least one processor individually or collectively, further cause the electronic device to:
obtain a pre-trained base model;
obtain an inference model by merging one or more weighted matrices of the calibrated combined adapter with a weighted matrix of the base model; and
obtain the output by inputting the user input into the inference model.

19. The electronic device of claim 12, wherein the instructions, when executed by the at least one processor individually or collectively, further cause the electronic device to:
obtain an additional user input from the user;
identify a third task and a fourth task, each corresponding to the additional user input;
combine a third adapter corresponding to the third task with a fourth adapter corresponding to the fourth task to generate an additional combined adapter;
calibrate the additional combined adapter by using the one or more calibration parameters;
generate an additional output corresponding to the additional user input, based on the calibrated additional combined adapter; and
provide the additional output to the user.

20. The electronic device of claim 12, wherein the instructions, when executed by the at least one processor individually or collectively, further cause the electronic device to:
obtain an additional user input from the user;
identify a third task and a fourth task, each corresponding to the additional user input;
combine a third adapter corresponding to the third task with a fourth adapter corresponding to the fourth task to generate an additional combined adapter;
calibrate the additional combined adapter by using one or more additional calibration parameters corresponding to a combination of the third task and the fourth task;
generate an additional output corresponding to the additional user input, based on the calibrated additional combined adapter; and
provide the additional output to the user.
